(19) United States
(12) Patent Application Publication
(10) Pub. No.: US 2026/0003143 A1
(43) Pub. Date: Jan. 1, 2026

(54) SEMICONDUCTOR PACKAGE AND METHOD OF MANUFACTURING THE SAME

(71) Applicant: Samsung Electronics Co., Ltd., Suwon-si (KR)

(72) Inventors: HYEONJEONG HWANG, Suwon-si (KR); JUNGHOON KANG, Suwon-si (KR)

(21) Appl. No.: 19/059,841

(22) Filed: Feb. 21, 2025

(30) Foreign Application Priority Data
Jun. 28, 2024 (KR) 10-2024-0085707

(51) Int. Cl. G02B 6/42

(52) U.S. Cl. CPC G02B 6/4268; G02B 6/4214; G02B 6/4273

(57) ABSTRACT

A semiconductor package includes a redistribution layer, a first semiconductor chip arranged on one surface of the redistribution layer, a photonic integrated circuit (PIC) arranged on one side of the first semiconductor chip on the redistribution layer, and a layer structure arranged on the first semiconductor chip and the PIC. The layer structure may radiate heat generated in the first semiconductor chip to an outside and transmit light incident from the outside to the PIC. Alternatively, the layer structure may transmit light generated in the PIC to the outside.

### CROSS-REFERENCE TO RELATED APPLICATION

This application claims the benefit of Korean Patent Application No. 10-2024-0085707 filed on Jun. 28, 2024, in the Korean Intellectual Property Office, the entire disclosure of which is herein incorporated by reference for all purposes.

### BACKGROUND

### 1. Field of the Invention

The various embodiments below relate to a semiconductor package and a method of manufacturing the semiconductor package, and more particularly, to a semiconductor package including a plurality of semiconductor chips and a method of manufacturing the same.

### 2. Description of the Related Art

The discovery of technologies, materials, and manufacturing procedures has led to the rapid development of computing power and wireless communication technology. Accordingly, high integration of high-performance transistors is enabled, and the integration speed has doubled every 18 months according to Moore's law. System packaging, in which a system is embodied in a package, is suggested as an effective solution to make the system lightweight, thin, short, small, and power efficient.

Examples of system packaging technology include integration of a logic circuit and a memory circuit, sensor packaging, heterogeneous integration of micro-electromechanical systems (MEMS) and a complementary metal-oxide-semiconductor (CMOS) logic circuit. System packaging enables the reduction in form factors as well as high reliability, low power consumption, and low manufacturing costs. Due to recent advancements in high integration, various methods have been proposed to effectively cool the significant heat generated by a semiconductor package.

With the growing demand for high integration and large capacity of electronic devices and the increase of multimedia information, photonic integrated circuits (PICs) that utilize optical interconnection for communication between various components within a system have become widely used.

### SUMMARY

The present disclosure provides a semiconductor package with improved space efficiency by forming an optical transmission path through a layer structure and a method of manufacturing the same.

The present disclosure provides a semiconductor package with improved reliability by having excellent heat dissipation performance and a method of manufacturing the same.

According to an aspect of the present disclosure, there is provided a semiconductor package including a redistribution layer, a first semiconductor chip arranged on a first surface of the redistribution layer, a photonic integrated circuit (PIC) arranged on the first surface and adjacent to a side surface of the first semiconductor chip, and a layer structure arranged on the first semiconductor chip and the PIC. The layer structure may radiate heat generated from the first semiconductor chip to an outside and transmit light incident from the outside to the PIC. Alternatively, the layer structure may transmit light generated from the PIC to the outside.

The semiconductor package may further include a second semiconductor chip arranged on the first surface of the redistribution layer and adjacent to a second side surface, opposite to the first side surface, of the first semiconductor chip.

The layer structure may include a heat dissipation layer arranged on the first semiconductor chip or the second semiconductor chip, and an optical transport layer arranged on the PIC.

The layer structure may further include a heat blocking layer arranged between the heat dissipation layer and the second semiconductor chip.

The semiconductor package may further include an optical element arranged between the optical transport layer of the layer structure and the PIC.

The optical transport layer may be formed of a plurality of layers extending in a direction perpendicular to the first surface of the redistribution layer, and a waveguide pattern may be formed in each of the layers.

The optical transport layer may be formed of a plurality of layers extending in a direction parallel to the upper surface of the redistribution layer, and a waveguide pattern may be formed in each of the layers.

A surface where the optical transport layer and the heat dissipation layer contact each other may be inclined with respect to an upper surface of the PIC.

The semiconductor package may further include a mirror arranged on a surface where the optical transport layer and the heat dissipation layer face each other. The mirror may be inclined with respect to an upper surface of the PIC.

One portion of the optical transport layer and one portion of the heat dissipation layer may overlap each other in a vertical direction perpendicular to the first surface of the redistribution layer. The one portion of the optical transport layer may contact the PIC. The one portion of the heat dissipation layer may be spaced apart from the PIC.

The semiconductor package may further include an electronic integrated circuit (EIC) arranged beneath the PIC.

The PIC and the EIC may be electrically connected to each other by a through-via.

Bottom surfaces of the EIC, the first semiconductor chip, and the second semiconductor chip may be positioned at a same height.

The semiconductor package may further include a dummy insulating layer arranged between the layer structure and the PIC.

The semiconductor package may further include pads arranged between the first surface of the redistribution layer and each of the EIC, the first semiconductor chip, and the second semiconductor chip.

The semiconductor package may further include a connecting terminal arranged on a second surface, opposite to the first surface, of the redistribution layer.

According to an aspect, there is provided a method of manufacturing a semiconductor package, the method including forming a layer structure on a carrier, and arranging at least one semiconductor chip, a PIC, and an EIC on the layer structure. The forming of the layer structure may include forming a heat dissipation layer on one side of the layer structure to radiate heat generated from the at least one semiconductor chip to an outside of the semiconductor package, and forming an optical transport layer on the other side of the layer structure to transmit light incident from the outside of the semiconductor package to the PIC or transmit light generated from the PIC to the outside of the semiconductor package.

The forming of the layer structure may further include forming a heat blocking layer on one portion of the heat dissipation layer.

The arranging of the at least one semiconductor chip including a first semiconductor chip and a second semiconductor chip, the PIC, and the EIC may include arranging the first semiconductor chip on the layer structure and contacting the heat dissipation layer, arranging the second semiconductor chip on the layer structure and contacting the heat blocking layer, arranging the PIC on the layer structure and contacting the optical transport layer, and arranging the EIC on the PIC.

The method may further include electrically connecting the PIC and the EIC with each other through a through-via, forming pads on the EIC, the first semiconductor chip, and the second semiconductor chip, and forming a filling insulating layer to fill the semiconductor package.

The method may further include forming a redistribution layer electrically connected to the pads, and forming a connecting terminal on the redistribution layer.

Additional aspects of embodiments will be set forth in part in the description which follows and, in part, will be apparent from the description, or may be learned by practice of the disclosure.

A semiconductor package and a method of manufacturing the semiconductor package according to the present disclosure may improve space efficiency by forming an optical transmission path through a layer structure.

A semiconductor package and a method of manufacturing the semiconductor package according to the present disclosure may improve cooling efficiency and alleviate thermal coupling between semiconductor chips by forming a thermal dissipation path through a layer structure.

A method of manufacturing a semiconductor package according to the present disclosure may reduce manufacturing costs by using a glass carrier.

In conclusion, a semiconductor package and a method of manufacturing the semiconductor package according to the present disclosure may implement a semiconductor package that is more compact and improved in electrical and thermal characteristics.

The effects to be achieved by the embodiments of the present disclosure are not limited to those described above, and other effects not mentioned above will be clearly derived and understood by one of ordinary skill in the art to which the embodiments pertain from the following description. That is, effects not intended by the embodiments of the present disclosure may be derived by one of ordinary skill in the art from those embodiments.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a plan view illustrating a semiconductor package according to various embodiments of the present disclosure;

FIG. 2 is a cross-sectional view taken along line I-I′ of FIG. 1, illustrating a semiconductor package according to an embodiment of the present disclosure;

FIGS. 3 and 4 are cross-sectional views taken along line I-I′ of FIG. 1, illustrating a semiconductor package according to another embodiment of the present disclosure;

FIG. 5 is a cross-sectional view taken along line I-I′ of FIG. 1, illustrating a semiconductor package according to still another embodiment of the present disclosure;

FIG. 6 is a cross-sectional view taken along line I-I′ of FIG. 1, illustrating a semiconductor package according to still another embodiment of the present disclosure;

FIG. 7 is a cross-sectional view taken along line I-I′ of FIG. 1, illustrating a semiconductor package according to still another embodiment of the present disclosure;

FIG. 8 is a cross-sectional view taken along line I-I′ of FIG. 1, illustrating a semiconductor package according to still another embodiment of the present disclosure;

FIGS. 9 and 10 are cross-sectional views taken along line I-I′ of FIG. 1, illustrating a semiconductor package according to another embodiment of the present disclosure;

FIG. 11 is a cross-sectional view taken along line I-I′ of FIG. 1, illustrating a semiconductor package according to still another embodiment of the present disclosure;

FIG. 12 is a cross-sectional view taken along line I-I′ of FIG. 1, illustrating a semiconductor package according to still another embodiment of the present disclosure;

FIG. 13 is a cross-sectional view taken along line I-I′ of FIG. 1, illustrating a semiconductor package according to still another embodiment of the present disclosure;

FIG. 14 is a cross-sectional view taken along line I-I′ of FIG. 1, illustrating a semiconductor package according to still another embodiment of the present disclosure;

FIG. 15 is a flowchart illustrating a method of manufacturing a semiconductor package according to an embodiment of the present disclosure;

FIGS. 16 to 26 illustrate a process of manufacturing a semiconductor package according to an embodiment of the present disclosure; and

FIGS. 27 to 32 illustrate a portion of a process of manufacturing a semiconductor package according to another embodiment of the present disclosure.

### DETAILED DESCRIPTION

Hereinafter, embodiments will be described in detail with reference to the accompanying drawings. However, various alterations and modifications may be made to the embodiments. The embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

The same name may be used to describe an element included in the embodiments described above and an element having a common function. Unless otherwise mentioned, the descriptions of the examples may be applicable to the following examples and thus, duplicated descriptions will be omitted for conciseness.

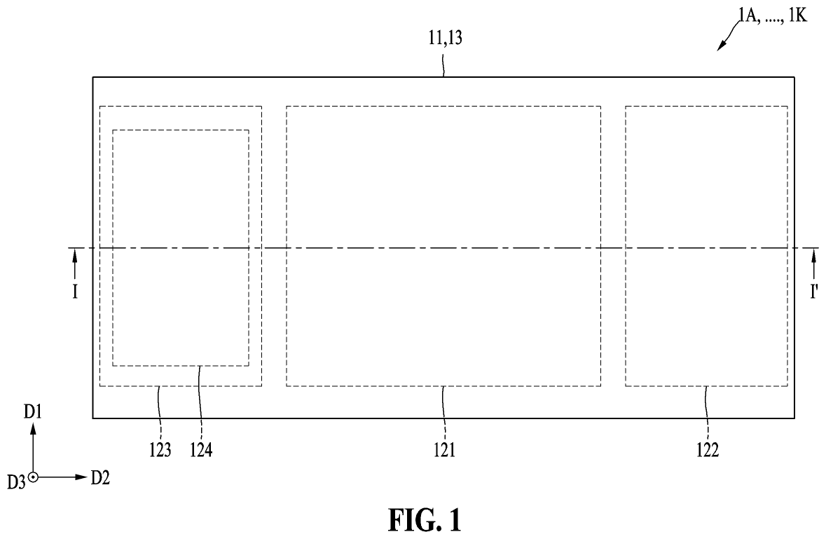

FIG. 1 is a plan view illustrating a semiconductor package according to various embodiments of the present disclosure.

A first direction D1 and a second direction D2 may be directions that are parallel to a bottom surface of a semiconductor package. The first direction D1 may be perpendicular to the second direction D2. A third direction D3 may be a direction perpendicular to the bottom surface, and may be perpendicular to the first direction D1 and the second direction D2.

Referring to FIG. 1, a semiconductor package 1A, 1B, . . . , 1K according to various embodiments of the present disclosure may include a redistribution layer 11, a first semiconductor chip 121, a second semiconductor chip 122, a photonic integrated circuit (PIC) 123, an electronic integrated circuit (EIC) 124, and a layer structure 13. The first semiconductor chip 121 and the second semiconductor chip 122 may be arranged side by side in the first direction D1 and the second direction D2. The PIC 123 and the EIC 124 may be stacked and arranged in the third direction D3. The redistribution layer 11 or the layer structure 13 may be arranged on or beneath the first semiconductor chip 121, the second semiconductor chip 122, the PIC 123, and the EIC 124 in the third direction D3.

Although it is shown that the redistribution layer 11 and the layer structure 13 have the same area for the first direction D1 and the second direction D2, embodiments are not necessarily limited thereto. The layer structure 13 may have a smaller area than the redistribution layer 11 for the first direction D1 and the second direction D2.

Although it is shown that the PIC 123 has a larger area than the EIC 124 for the first direction D1 and the second direction D2, embodiments are not necessarily limited thereto. The PIC 123 may have a smaller area than the EIC 124 for the first direction D1 and the second direction D2, or both may have the same area.

Although it is shown that the first semiconductor chip 121 and the second semiconductor chip 122 are arranged simultaneously, embodiments are not necessarily limited thereto. Only the first semiconductor chip 121 may be arranged, and the second semiconductor chip 122 may be omitted. Conversely, only the second semiconductor chip 122 may be arranged, and the first semiconductor chip 121 may be omitted.

Although it is shown that the first semiconductor chip 121 has a larger area than the second semiconductor chip 122 for the first direction D1 and the second direction D2, embodiments are not necessarily limited thereto. The first semiconductor chip 121 may have a smaller area than the second semiconductor chip 122 for the first direction D1 and the second direction D2, or both may have the same area.

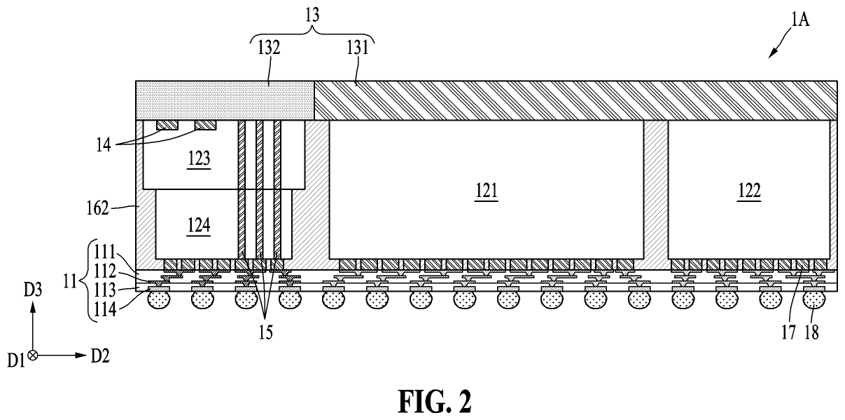

FIG. 2 is a cross-sectional view taken along line I-I′ of FIG. 1, illustrating a semiconductor package according to an embodiment of the present disclosure.

Referring to FIG. 2, a semiconductor package 1A according to an embodiment of the present disclosure may include a redistribution layer 11, a first semiconductor chip 121, a second semiconductor chip 122, a PIC 123, an EIC 124, and a layer structure 13.

The first semiconductor chip 121 may be arranged on one surface of the redistribution layer 11. The second semiconductor chip 122 may be arranged on the other side of the first semiconductor chip 121 on the one surface of the redistribution layer 11. The PIC 123 and the EIC 124 may be arranged on one side of the first semiconductor chip 121 on the redistribution layer 11. The PIC 123 may be arranged on the EIC 124 in the third direction D3. For example, the PIC 123 may be stacked on the EIC 124 in the third direction D3 so that the PIC 123 is adjacent to the layer structure 13 and the EIC 124 is adjacent to the redistribution layer 11.

Although it is shown that the first semiconductor chip 121 is arranged in the central portion of the semiconductor package 1A, the second semiconductor chip 122 is arranged in the other side portion of the semiconductor package 1A, and the PIC 123 and the EIC 124 are arranged in one side portion of the semiconductor package 1A, embodiments are not necessarily limited thereto. For example, the PIC 123 and the EIC 124 may be arranged in the central portion of the semiconductor package 1A, and the first semiconductor chip 121 and the second semiconductor chip 122 may be arranged in both side portions of the semiconductor package 1A, respectively.

The first semiconductor chip 121 or the second semiconductor chip 122 may include a logic chip. The logic chip may include a plurality of logic elements (not shown) therein. The logic elements may be elements configured to process various signals, including logic circuits such as AND, OR, NOT, and flip-flop. In some embodiments, the logic elements may be elements configured to perform signal processing, such as analog signal processing, analog-to-digital (A/D) conversion, and control.

In some embodiments, the first semiconductor chip 121 or the second semiconductor chip 122 may be implemented as a microprocessor, a graphics processor, a signal processor, a network processor, a chipset, an application processor, a system-on-chip, or an application-specific integrated circuit (ASIC), depending on its function.

The PIC 123 may transmit information using an optical signal rather than an electrical signal. The PIC 123 may include a light source (not shown) configured to convert electrical energy into optical energy, an optical modulator (not shown) configured to modulate light, an optical waveguide (not shown) configured to transmit an optical signal, an optical antenna (not shown) or optical coupler (not shown) configured to emit light inside the optical waveguide to the outside of a PIC chip or receive light from the outside the PIC chip into the optical waveguide, or an optical receiver (not shown) configured to convert optical energy into electrical energy. The PIC 123 may further include input/output terminals for outputting light or receiving light. Most of these elements integrated in the PIC 123 may be formed of materials that are easy to form on a substrate.

The EIC 124 may be a circuit configured to control the operation of the PIC 123. The EIC 124 may include an integrated circuit for interfacing with the PIC 123. For example, the EIC 124 may include a controller (not shown), a driver (not shown), a transimpedance amplifier (not shown), or a combination thereof. The EIC 124 may include a central processing unit (CPU) in some embodiments. The EIC 124 may include a circuit configured to process an electrical signal received from the PIC 123. The EIC 124 may control signaling of the PIC 123 based on an electrical signal (e.g., digital or analog signal) received from another device or chip. The EIC 124 may provide a serializer/deserializer (SerDes) function. In this manner, the EIC 124 may act as part of an input/output (I/O) interface between an optical signal and an electrical signal within the semiconductor package 1A including the PIC 123.

The layer structure 13 may be arranged on the first semiconductor chip 121, the second semiconductor chip 122, and the PIC 123. The layer structure 13 may radiate heat generated in the first semiconductor chip 121 or the second semiconductor chip 122 to the outside of the semiconductor package 1A. The layer structure 13 may transmit light incident from the outside of the semiconductor package 1A to the PIC 123. Alternatively, the layer structure 13 may transmit light generated in the PIC 123 to the outside of the semiconductor package 1A.

The layer structure 13 may include a heat dissipation layer 131 arranged on the first semiconductor chip 121 or the second semiconductor chip 122 and an optical transport layer 132 arranged on the PIC 123.

The top surface of the first semiconductor chip 121 or the second semiconductor chip 122 may be arranged in contact with the bottom surface of the heat dissipation layer 131. The top surface of the PIC 123 may be arranged in contact with the bottom surface of the optical transport layer 132.

Heat generated in the first semiconductor chip 121 or the second semiconductor chip 122 may be quickly radiated to the outside of the semiconductor package 1A through the heat dissipation layer 131. The heat dissipation layer 131 may be formed as a heat spreader, a heat slug, a heat sink, or a vapor chamber. The heat dissipation layer 131 may include a metal material such as copper (Cu), aluminum (Al), and stainless steel (SUS), but is not limited thereto.

The semiconductor package 1A may further include a thermal interface material (TIM) layer (not shown) arranged between the top surface of the first semiconductor chip 121 or the second semiconductor chip 122 and the bottom surface of the heat dissipation layer 131. The TIM layer (not shown) may be arranged to effectively transfer heat from the first semiconductor chip 121 or the second semiconductor chip 122 to the heat dissipation layer 131. The TIM layer (not shown) may also function as an adhesive layer between the first semiconductor chip 121 or the second semiconductor chip 122 and the heat dissipation layer 131. The stability and mechanical reliability of the semiconductor package 1A may improve through the TIM layer (not shown).

A waveguide pattern may be formed on the optical transport layer 132. The optical transport layer 132 may be formed of an organic material with a waveguide pattern formed thereon. For example, the optical transport layer 132 may be formed of an epoxy-based material, polyimide-based material, or siloxane polymer-based material with a waveguide pattern formed thereon. In an embodiment, the waveguide pattern may be formed in the optical transport layer 132 (e.g., may be formed or buried in the organic material of the optical transport layer 132). For example, the optical transport layer 132 may be formed of an epoxy-based material, polyimide-based material, or siloxane polymer-based material with a waveguide pattern formed therein. The optical transport layer 132 may be formed of a material that is impregnated with epoxy resin and a plurality of glass fibers overlapping each other in the material. The optical transport layer 132 may include polyimide, benzocyclobutene (BCB), polybenzoxazole (PBO), a fluorinated polymer, polynorbornene, silicone, siloxane acrylate, or an epoxy nano-filled phenol resin, but is not necessarily limited thereto. The optical transport layer 132 may be formed of a polymer material having low intrinsic attenuation characteristics, high thermal/mechanical characteristics, low birefringence characteristics, or refractive index tunability characteristics. The optical transport layer 132 may be formed of a material with low optical loss. Light may be transmitted from the outside to the inside of the semiconductor package 1A or from the inside to the outside of the semiconductor package 1A through the waveguide pattern formed on the optical transport layer 132.

The semiconductor package 1A may include an optical element 14 arranged between the optical transport layer 132 of the layer structure 13 and the PIC 123. The optical element 14 may refer to a region for transmitting and receiving light inside the PIC 123. As an example, the optical element 14 may include an optical redistribution layer and/or an optical signal modulator. The optical redistribution layer may be formed of a material capable of transmitting light. For example, the optical redistribution layer may be formed of polymethyl methacrylate, but is not necessarily limited thereto. The optical redistribution layer may also be formed of the material that forms the optical transport layer 132 described above.

The optical element 14 may connect the optical transport layer 132 and the PIC 123. Light incident from the outside of the semiconductor package 1A may pass through the optical transport layer 132 and then may be transmitted to the PIC 123 through the optical element 14. Conversely, light generated in the PIC 123 may be transmitted to the optical transport layer 132 through the optical element 14 and then transmitted to the outside of the semiconductor package 1A. An electrical wiring (not shown) may optionally be formed between one end portion of the optical element 14 and the PIC 123.

The bottom surface of the PIC 123 may be arranged in contact with the top surface of the EIC 124. The PIC 123 and the EIC 124 may be electrically connected to each other by through-vias 15. The through-vias 15 may be formed as through-silicon vias (TSVs). A hybrid copper bonding method may be used to form the TSVs. The through-vias 15 may penetrate through the PIC 123 and the EIC 124 and extend in the third direction D3.

The bottom surfaces of the EIC 124, the first semiconductor chip 121, and the second semiconductor chip 122 may be positioned at the same height in the third direction D3. The first semiconductor chip 121 and the second semiconductor chip 122 may have the same length in the third direction D3 (i.e., the same thickness in the third direction D3). The sum of the length of the PIC 123 and the length of the EIC 124 in the third direction D3 may be equal to the length of the first semiconductor chip 121. However, embodiments are not necessarily limited thereto.

Pads 17 may be arranged between the EIC 124 and the redistribution layer 11, between the first semiconductor chip 121 and the redistribution layer 11, and between the second semiconductor chip 122 and the redistribution layer 11 to be described later. One end portions of the pads 17 may be connected to the bottom surfaces of the EIC 124, the first semiconductor chip 121, and the second semiconductor chip 122. The other end portions of the pads 17 may be connected to the top surface of the redistribution layer 11. The EIC 124, the first semiconductor chip 121, and the second semiconductor chip 122 may be electrically connected to the redistribution layer 11 by the pads 17. One end portions of the through-vias 15 described above may also be electrically connected to the pads 17.

The first semiconductor chip 121, the second semiconductor chip 122, the PIC 123, and the EIC 124 may be electrically connected to each other through the through-vias 15, the pads 17, and the redistribution layer 11.

The pads 17 may be formed as bumps, but are not necessarily limited thereto. The pads 17 may be formed of a conductive material such as copper. However, embodiments are not necessarily limited thereto, and the pads 17 may be formed of other conductive materials. The pads 17 may be formed in length of about 3 micrometers (μm) in the third direction D3, but are not necessarily limited thereto.

The redistribution layer 11 may include a plurality of redistribution patterns, a bump pattern, and a redistribution insulating layer. In some embodiments, a plurality of redistribution insulating layers may be stacked. The redistribution insulating layer may be formed from, for example, photo imageable dielectric (PID) or photosensitive polyimide (PSPI). The redistribution patterns and the bump pattern may be a metal such as, for example, copper (Cu), aluminum (Al), tungsten (W), titanium (Ti), tantalum (Ta), indium (In), molybdenum (Mo), manganese (Mn), cobalt (Co), tin (Sn), nickel (Ni), magnesium (Mg), rhenium (Re), beryllium (Be), gallium (Ga), ruthenium (Ru), and an alloy thereof, but are not limited thereto. In some embodiments, the redistribution patterns and the bump pattern may be formed by stacking the metal or alloys mentioned above on a seed layer including titanium, titanium nitride, or titanium tungsten.

For example, the redistribution layer 11 may include a first redistribution insulating layer 111, a second redistribution insulating layer 113 arranged beneath the first redistribution insulating layer 111, a plurality of redistribution patterns 112 arranged in the first redistribution insulating layer 111, and a bump pattern 114 arranged in the second redistribution insulating layer 113.

The bump pattern 114 may be arranged on the lowest side of the redistribution layer 11. The bottom surface of the bump pattern 114 may not be covered by the second redistribution insulating layer 113. The bump pattern 114 may function as pads of connecting terminals 18 to be described later. A plurality of bump patterns 114 may be spaced laterally from each other and electrically insulated from each other. The plurality of bump patterns 114 being spaced apart from each other may indicate that the bump patterns 114 are spaced apart from each other in the second direction D2 parallel to the bottom surface of the redistribution layer 11.

A redistribution pattern 112 may be arranged on the bump pattern 114. A redistribution pattern 112 may be electrically connected to the bump pattern 114. A plurality of redistribution patterns 112 arranged on the same line in the second direction D2 may be spaced apart from each other and electrically disconnected from each other. Some of the plurality of redistribution patterns 112 arranged at different heights in the third direction D3 may be electrically connected to each other.

A redistribution pattern 112 may include a via portion and a wiring portion. The via portion may be a component for vertical connection, and the wiring portion may be a component for horizontal connection. The via portion may be a portion of the redistribution pattern 112 extending in the third direction D3, and the wiring portion may be a portion of the redistribution pattern 112 extending in the second direction D2. The width of the wiring portion may be larger than the width of the via portion.

The semiconductor package 1A may include a connecting terminal 18 arranged on the other surface of the redistribution layer 11. A plurality of connecting terminals 18 may be formed on the bottom surface of the redistribution layer 11. The semiconductor package 1A may be electrically connected to another semiconductor package or package board through the connecting terminal 18. In the drawing, the connecting terminal 18 is depicted as a ball, but is not limited thereto. For example, the connecting terminal 18 may be a bump or a conductive tab. In an embodiment, the connecting terminal 18 may be arranged in a grid array.

An interposer may be implemented by a redistribution layer and a connecting terminal.

The semiconductor package 1A may include a filling insulating layer 162 surrounding the first semiconductor chip 121, the second semiconductor chip 122, the PIC 123, and the EIC 124. The filling insulating layer 162 may fill the inside of the semiconductor package 1A. The filling insulating layer 162 may be formed of an epoxy-based resin or a phenol resin. However, embodiments are not necessarily limited thereto.

Hereinafter, a repeated description of the technical ideas described above that is identically applicable is omitted, and differences between semiconductor packages according to various other embodiments are described.

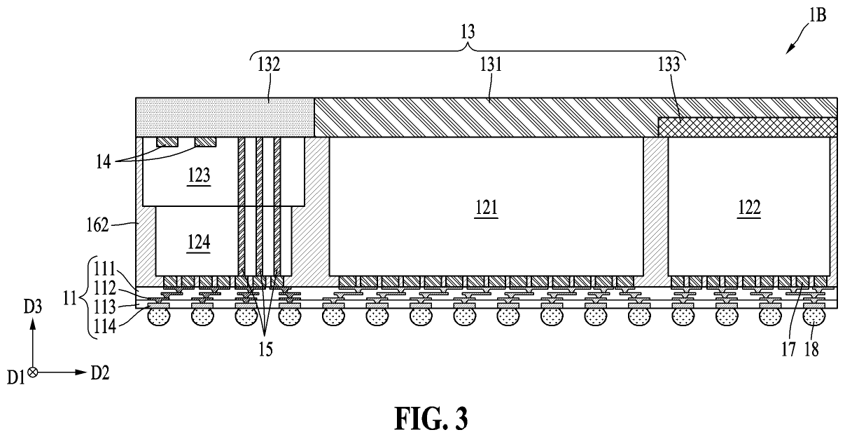

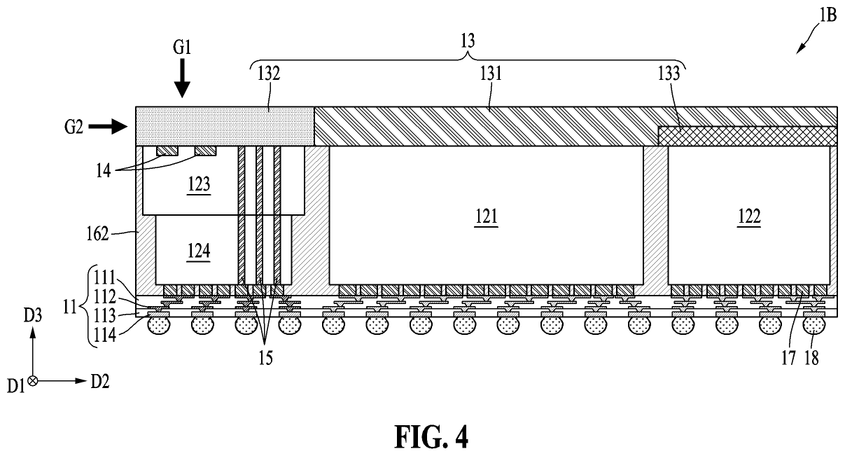

FIGS. 3 and 4 are cross-sectional views taken along line I-I′ of FIG. 1, illustrating a semiconductor package according to another embodiment of the present disclosure.

Referring to FIG. 3, the layer structure 13 of a semiconductor package 1B according to another embodiment of the present disclosure may further include a heat blocking layer 133 arranged between the heat dissipation layer 131 and the second semiconductor chip 122. The heat blocking layer 133 may be formed of a polymer-based material. However, embodiments are not necessarily limited thereto.

In this case, the first semiconductor chip 121 and the second semiconductor chip 122 may each perform a different function.

The first semiconductor chip 121 may include a logic chip. The logic chip may include a plurality of logic elements (not shown) therein. The logic elements may be elements configured to process various signals, including logic circuits such as AND, OR, NOT, and flip-flop. In some embodiments, the logic elements may be elements configured to perform signal processing, such as analog signal processing, analog-to-digital (A/D) conversion, and control.

In some embodiments, the first semiconductor chip 121 may be implemented as a microprocessor, a graphics processor, a signal processor, a network processor, a chipset, an application processor, a system-on-chip, or an application-specific integrated circuit (ASIC), depending on its function.

The second semiconductor chip 122 may include a volatile memory chip and/or a non-volatile memory chip. The volatile memory chip may be, for example, dynamic random access memory (DRAM), static RAM (SRAM), or thyristor RAM (TRAM). The non-volatile memory chip may be, for example, flash memory, magnetic RAM (MRAM), spin-transfer torque magnetoresistive random-access memory (STT-MRAM), ferroelectric RAM (FRAM), phase-change RAM (PRAM), or resistive RAM (RRAM).

In some embodiments, the second semiconductor chip 122 may include a memory chiplet including a plurality of memory chips capable of merging data with each other. The second semiconductor chip 122 may be a high-performance memory chip, such as a high bandwidth memory (HBM) chip.

The heat blocking layer 133 may prevent heat generated in the first semiconductor chip 121 from being transmitted to the second semiconductor chip 122. As described above, the heat generated in the first semiconductor chip 121 may be radiated to the outside of the semiconductor package 1B by means of the heat dissipation layer 131. In this process, the heat needs to be prevented from being transmitted to the second semiconductor chip 122 through the heat dissipation layer 131. The heat blocking layer 133 may be arranged between the top surface of the second semiconductor chip 122 and the bottom surface of the heat dissipation layer 131 facing the second semiconductor chip 122, so that the transfer of heat from the heat dissipation layer 131 to the second semiconductor chip 122 may be effectively prevented by the heat blocking layer 133. For example, since the second semiconductor chip 122 dissipates less heat compared to the first semiconductor chip 121, it may serve as a heat sink and the heat dissipated by the first semiconductor chip 121 may flow into the first semiconductor chip 121 through the heat dissipation layer 131. In an embodiment, the heat blocking layer 133 may block such heat from the first semiconductor chip 121 toward the second semiconductor chip 122. The heat blocking layer 133 may contact an upper surface of the second semiconductor chip 122, and cover the entirety of the upper surface of the second semiconductor chip 122.

Referring to FIG. 4, light G1 incident from the outside of the semiconductor package 1B toward the layer structure 13 in the third direction D3 may pass through the optical transport layer 132 and may be transmitted to the PIC 123. Light G2 incident from the outside of the semiconductor package 1B toward the layer structure 13 in the second direction D2 may pass through the optical transport layer 132 and may be transmitted to the PIC 123. Both the light G1 vertically incident to the optical transport layer 132 and the light G2 horizontally incident to the optical transport layer 132 may pass through the optical transport layer 132 and may be transmitted to the PIC 123.

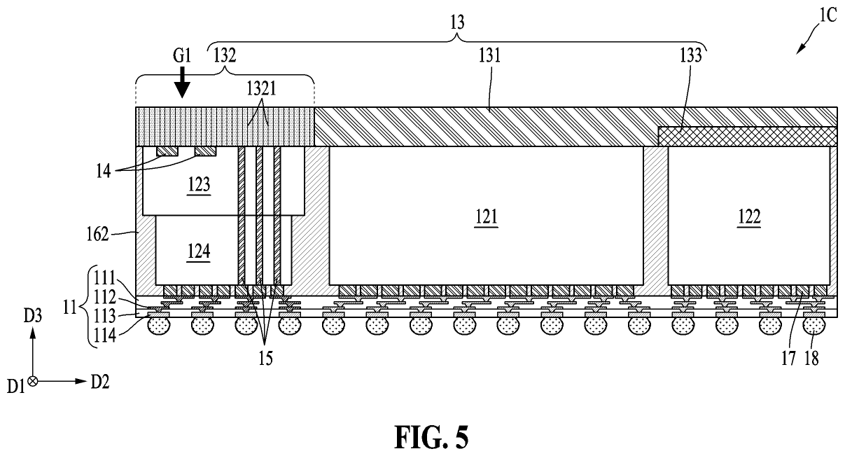

FIG. 5 is a cross-sectional view taken along line I-I′ of FIG. 1, illustrating a semiconductor package according to still another embodiment of the present disclosure.

Referring to FIG. 5, the optical transport layer 132 of a semiconductor package 1C according to still another embodiment of the present disclosure may be formed of a plurality of layers 1321. The layers 1321 may be the same or different in light transmittance. The layers 1321 may extend in a direction perpendicular to an upper surface of the redistribution layer 11, for example, in the third direction D3. A waveguide pattern may be formed in each of the layers 1321. In an embodiment, the waveguide pattern may be formed of a material with a high refractive index, which is surrounded by a material with a lower refractive index. For example, each layer may include a first material having a lower refractive index and a second material having a high refractive index. Accordingly, light G1 vertically incident mainly to the optical transport layer 132 may pass through the optical transport layer 132 and may be transmitted to the PIC 123. The plurality of layers 1321 may be formed through a deposition process, and a separate bonding process is unnecessary for the layers 1321. However, embodiments are not necessarily limited thereto.

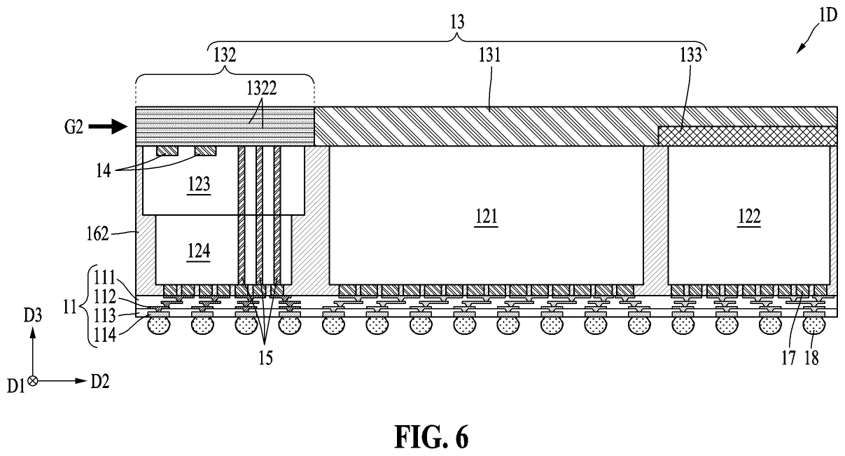

FIG. 6 is a cross-sectional view taken along line I-I′ of FIG. 1, illustrating a semiconductor package according to still another embodiment of the present disclosure.

Referring to FIG. 6, the optical transport layer 132 of a semiconductor package 1D according to still another embodiment of the present disclosure may be formed of a plurality of layers 1322. The layers 1322 may be the same or different in light transmittance. The layers 1322 may extend in a direction parallel to an upper surface of the redistribution layer 11, for example, in the second direction D2. A waveguide pattern may be formed in each of the layers 1322. Accordingly, light G2 horizontally incident mainly to the optical transport layer 132 may pass through the optical transport layer 132 and may be transmitted to the PIC 123. The plurality of layers 1322 may be formed through a deposition process, and a separate bonding process is unnecessary for the layers 1322. However, embodiments are not necessarily limited thereto.

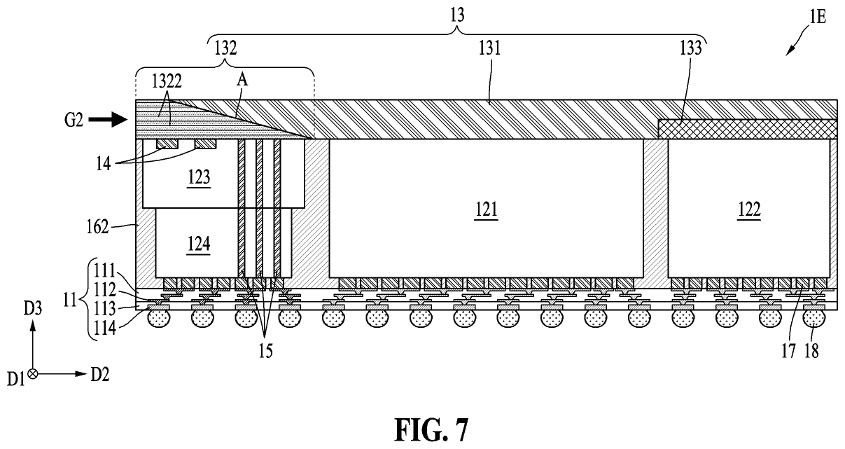

FIG. 7 is a cross-sectional view taken along line I-I′ of FIG. 1, illustrating a semiconductor package according to still another embodiment of the present disclosure.

Referring to FIG. 7, the optical transport layer 132 of a semiconductor package 1E according to still another embodiment of the present disclosure may be formed of a plurality of layers 1322. The layers 1322 may be the same or different in light transmittance. The layers 1322 may extend in a direction parallel to the upper surface of the redistribution layer 11, for example, in the second direction D2. A waveguide pattern may be formed in each of the layers 1322. Accordingly, light G2 horizontally incident mainly to the optical transport layer 132 may pass through the optical transport layer 132 and may be transmitted to the PIC 123. The plurality of layers 1322 may be formed through a deposition process, and a separate bonding process is unnecessary for the layers 1322. However, embodiments are not necessarily limited thereto.

A surface A where the optical transport layer 132 and the heat dissipation layer 131 face each other may be inclined in a direction toward the PIC 123. For example, the surface A may be inclined with respect to the upper surface of the PIC 123. Through this structure, light G2 horizontally incident to the optical transport layer 132 may be reflected from the surface A where the optical transport layer 132 and the heat dissipation layer 131 face each other. In an embodiment, the optical transport layer 132 and the heat dissipation layer 131 may contact each other to form the surface A. The light G2 traveling through the waveguide pattern to the surface A may be reflected in the third direction D3 from the surface A. The light G2 reflected in the third direction D3 from the surface A may be transmitted to the PIC 123.

The imaginary axis of the optical element 14 that penetrates through the optical element 14 and extends in the third direction D3 may penetrate through the surface A where the optical transport layer 132 and the heat dissipation layer 131 face each other. Through this arrangement of the optical element 14, the light G2 reflected from the surface A where the optical transport layer 132 and the heat dissipation layer 131 face each other may be effectively transmitted toward the optical element 14.

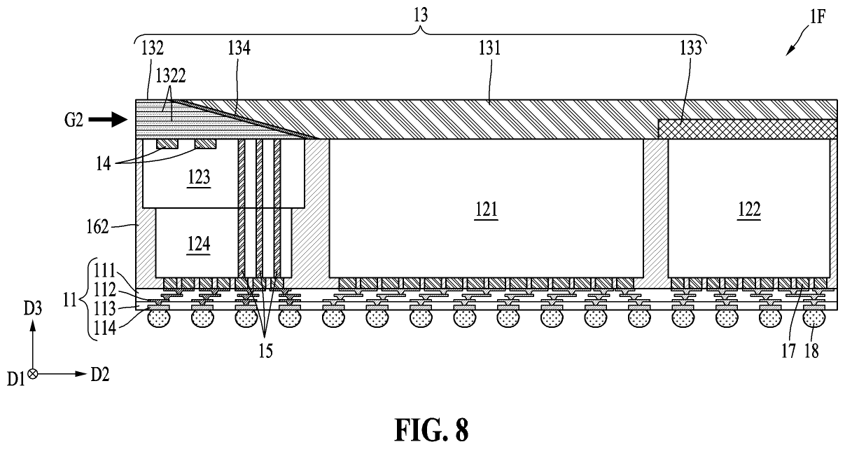

FIG. 8 is a cross-sectional view taken along line I-I′ of FIG. 1, illustrating a semiconductor package according to still another embodiment of the present disclosure.

Referring to FIG. 8, the optical transport layer 132 of a semiconductor package 1F according to still another embodiment of the present disclosure may be formed of a plurality of layers 1322. The layers 1322 may be the same or different in light transmittance. The layers 1322 may extend in a direction parallel to the upper surface of the redistribution layer 11, for example, in the second direction D2. A waveguide pattern may be formed in each of the layers 1322. Accordingly, light G2 horizontally incident mainly to the optical transport layer 132 may pass through the optical transport layer 132 and may be transmitted to the PIC 123. The plurality of layers 1322 may be formed through a deposition process, and a separate bonding process is unnecessary for the layers 1322. However, embodiments are not necessarily limited thereto.

A mirror 134 may be arranged in a space where the optical transport layer 132 and the heat dissipation layer 131 face each other. The space may be inclined in a direction toward the PIC 123. For example, the space may be inclined with respect to the upper surface of the PIC 123. Through this structure, light G2 horizontally incident to the optical transport layer 132 may be reflected by the mirror 134. The light G2 traveling through the waveguide pattern to the mirror 134 may be reflected in the third direction D3 by the mirror 134. The light G2 reflected in the third direction D3 by the mirror 134 may be transmitted to the PIC 123. In an embodiment, the mirror 134 that is disposed in the space may be inclined with respect to the upper surface of the PIC 123.

The imaginary axis of the optical element 14 that penetrates through the optical element 14 and extends in the third direction D3 may penetrate through a portion of the mirror 134. Through this arrangement of the optical element 14, the light G2 reflected from the mirror 134 may be effectively transmitted toward the optical element 14.

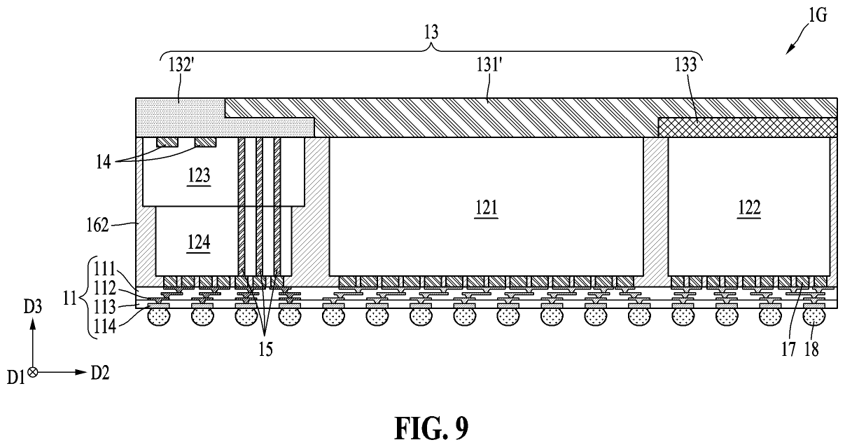

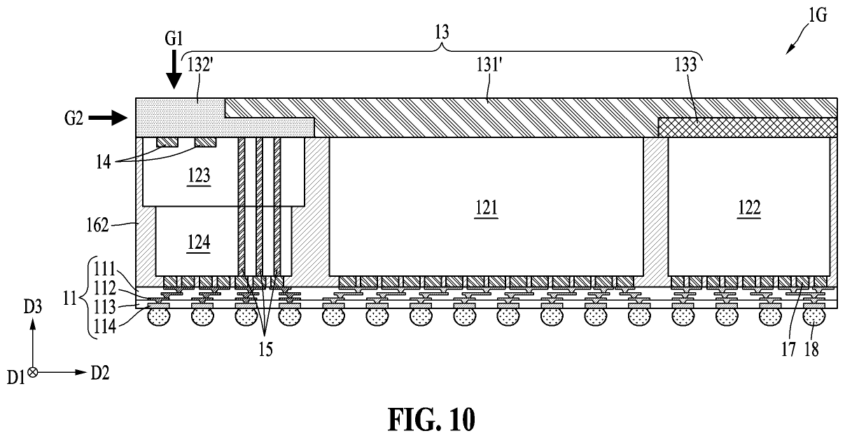

FIGS. 9 and 10 are cross-sectional views taken along line I-I′ of FIG. 1, illustrating a semiconductor package according to another embodiment of the present disclosure.

Referring to FIG. 9, one portion of an optical transport layer 132′ and one portion of a heat dissipation layer 131′ of a semiconductor package 1G according to still another embodiment of the present disclosure may overlap each other. For example, at a portion where the optical transport layer 132′ and the heat dissipation layer 131′ face each other, an upper portion of the heat dissipation layer 131′ may extend toward the optical transport layer 132′, and a lower portion of the optical transport layer 132′ may extend toward the heat dissipation layer 131′. The one portion of the optical transport layer 132′ overlapping the one portion of the heat dissipation layer 131′ may be arranged adjacent to the PIC 123. The one portion of the heat dissipation layer 131′ overlapping the one portion of the optical transport layer 132′ may be arranged spaced apart from the PIC 123.

This structure may further increase the volume of the heat dissipation layer 131′. For example, a surface through which the heat dissipates may increase in this partial overlapping structure of the heat dissipation layer 131′ and the optical transport layer 132′. Accordingly, heat generated in the first semiconductor chip 121 may be more effectively radiated to the outside of the semiconductor package 1G through the heat dissipation layer 131′ with increased volume. Meanwhile, the top surface of the PIC 123 may still maintain a structure in which the top surface of the PIC 123 can be in contact with the bottom surface of the optical transport layer 132′. Accordingly, light incident to the optical transport layer 132′ from the outside of the semiconductor package 1G may be effectively transmitted to the PIC 123.

Referring to FIG. 10, light G1 incident from the outside of the semiconductor package 1G toward the optical transport layer 132′ in the third direction D3 may pass through the optical transport layer 132′ and may be transmitted to the PIC 123. Light G2 incident from the outside of the semiconductor package 1G toward the optical transport layer 132′ in the second direction D2 may pass through the optical transport layer 132′ and may be transmitted to the PIC 123. Both the light G1 vertically incident to the optical transport layer 132′ and the light G2 horizontally incident to the optical transport layer 132′ may pass through the optical transport layer 132′ and may be transmitted to the PIC 123.

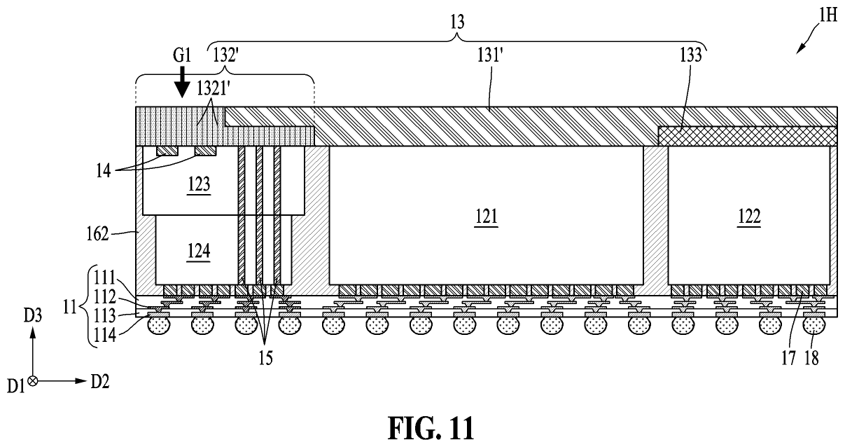

FIG. 11 is a cross-sectional view taken along line I-I′ of FIG. 1, illustrating a semiconductor package according to still another embodiment of the present disclosure.

Referring to FIG. 11, one portion of the optical transport layer 132′ and one portion of the heat dissipation layer 131′ of a semiconductor package 1H according to still another embodiment of the present disclosure may overlap each other. The optical transport layer 132′ may be formed of a plurality of layers 1321′. The layers 1321′ may be the same or different in light transmittance. The layers 1321′ may extend in a direction perpendicular to the redistribution layer 11, for example, in the third direction D3. A waveguide pattern may be formed in each of the layers 1321′. Accordingly, light G1 vertically incident mainly to the optical transport layer 132′ may pass through the optical transport layer 132′ and may be transmitted to the PIC 123. The plurality of layers 1321′ may be formed through a deposition process, and a separate bonding process is unnecessary for the layers 1321′. However, embodiments are not necessarily limited thereto.

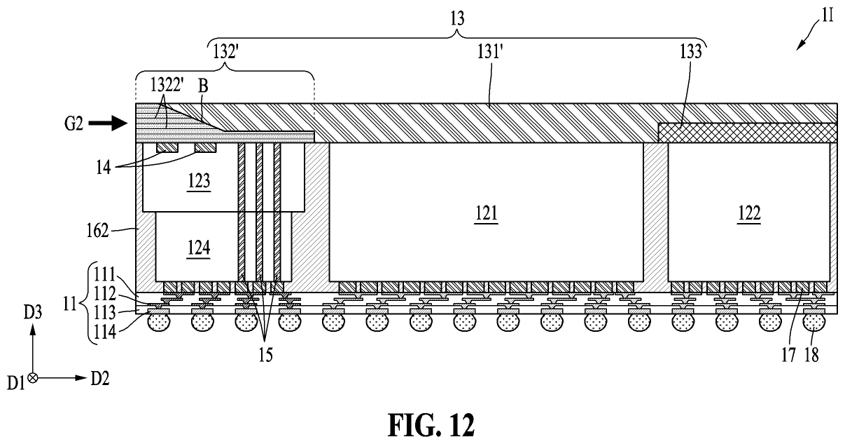

FIG. 12 is a cross-sectional view taken along line I-I′ of FIG. 1, illustrating a semiconductor package according to still another embodiment of the present disclosure.

Referring to FIG. 12, one portion of the optical transport layer 132′ and one portion of the heat dissipation layer 131′ of a semiconductor package 1I according to still another embodiment of the present disclosure may overlap each other. The optical transport layer 132′ may be formed of a plurality of layers 1322′. The layers 1322′ may be the same or different in light transmittance. The layers 1322′ may extend in a direction parallel to the redistribution layer 11, for example, in the second direction D2. A waveguide pattern may be formed in each of the layers 1322′. Accordingly, light G2 horizontally incident mainly to the optical transport layer 132′ may pass through the optical transport layer 132 and may be transmitted to the PIC 123. The plurality of layers 1322′ may be formed through a deposition process, and a separate bonding process is unnecessary for the layers 1322′. However, embodiments are not necessarily limited thereto.

A surface B where the optical transport layer 132′ and the heat dissipation layer 131′ face each other may be inclined in a direction toward the PIC 123. For example, an upper portion of the surface B where the optical transport layer 132′ and the heat dissipation layer 131′ face each other may be inclined in a direction toward the PIC 123. In an embodiment, the optical transport layer 132′ and the heat dissipation layer 131′ may contact each other to form the surface B. For example, the upper portion of the surface B may be inclined with respect to the upper surface of the PIC 123. Through this structure, light G2 horizontally incident to the optical transport layer 132′ may be reflected from the surface B where the optical transport layer 132′ and the heat dissipation layer 131′ face each other. The light G2 traveling through the waveguide pattern to the surface B may be reflected in the third direction D3 from the surface B where the optical transport layer 132′ and the heat dissipation layer 131′ face each other. The light G2 reflected in the third direction D3 from the surface B may be transmitted to the PIC 123.

The imaginary axis of the optical element 14 that penetrates through the optical element 14 and extends in the third direction D3 may penetrate through the surface B where the optical transport layer 132′ and the heat dissipation layer 131′ face each other. Through this arrangement of the optical element 14, the light G2 reflected from the surface B where the optical transport layer 132′ and the heat dissipation layer 131′ face each other may be effectively transmitted toward the optical element 14.

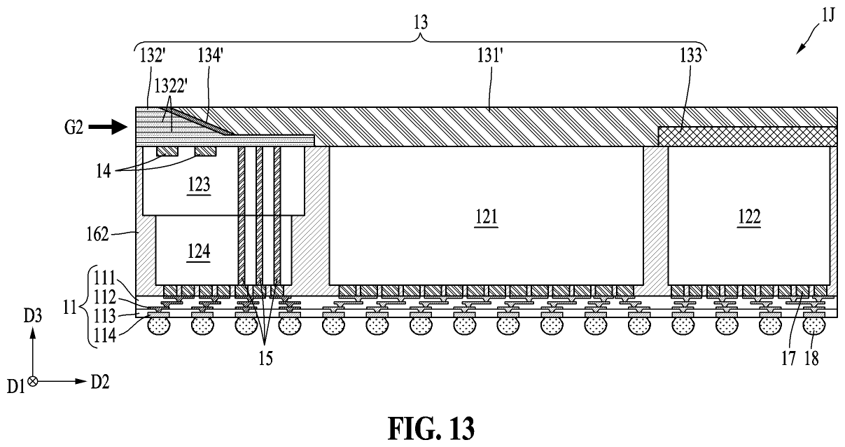

FIG. 13 is a cross-sectional view taken along line I-I′ of FIG. 1, illustrating a semiconductor package according to still another embodiment of the present disclosure.

Referring to FIG. 13, the optical transport layer 132 of a semiconductor package 1J according to still another embodiment of the present disclosure may be formed of the plurality of layers 1322′. The layers 1322′ may be the same or different in light transmittance. The layers 1322′ may extend in a direction parallel to the redistribution layer 11, for example, in the second direction D2. A waveguide pattern may be formed in each of the layers 1322′. Accordingly, light G2 horizontally incident mainly to the optical transport layer 132′ may pass through the optical transport layer 132 and may be transmitted to the PIC 123. The plurality of layers 1322′ may be formed through a deposition process, and a separate bonding process is unnecessary for the layers 1322′. However, embodiments are not necessarily limited thereto.

A mirror 134′ may be arranged in a space where the optical transport layer 132′ and the heat dissipation layer 131′ face each other. An upper portion of the space where the optical transport layer 132′ and the heat dissipation layer 131′ face each other may be inclined in a direction toward the PIC 123. For example, the upper portion of the space may be inclined with respect to the upper surface of the PIC 123. Through this structure, light G2 horizontally incident to the optical transport layer 132′ may be reflected by the mirror 134′. The light G2 traveling through the waveguide pattern to the mirror 134′ may be reflected in the third direction D3 from the mirror 134′. The light G2 reflected in the third direction D3 by the mirror 134′ may be transmitted to the PIC 123. In an embodiment, the mirror 134′ that is disposed in the upper portion of the space may be inclined with respect to the upper surface of the PIC 123.

The imaginary axis of the optical element 14 that penetrates through the optical element 14 and extends in the third direction D3 may penetrate through a portion of the mirror 134′. Through this arrangement of the optical element 14, the light G2 reflected from the mirror 134′ may be effectively transmitted toward the optical element 14.

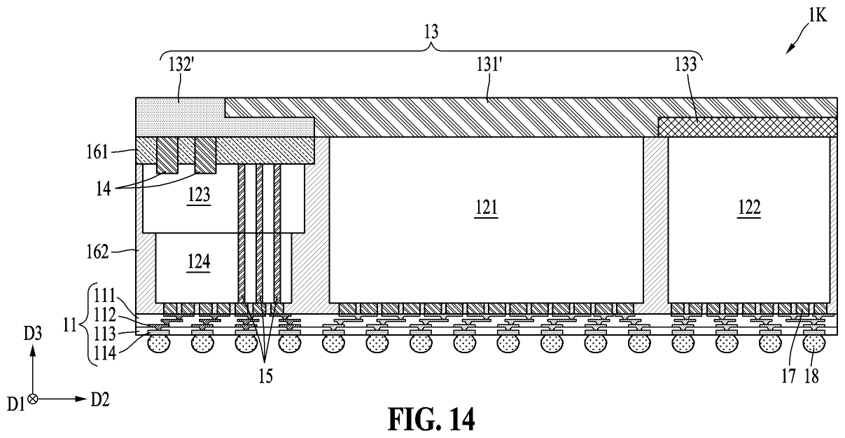

FIG. 14 is a cross-sectional view taken along line I-I′ of FIG. 1, illustrating a semiconductor package according to still another embodiment of the present disclosure.

Referring to FIG. 14, a semiconductor package 1K according to still another embodiment of the present disclosure may include a dummy insulating layer 161 arranged between the optical transport layer 132′ of the layer structure 13 and the PIC 123. The dummy insulating layer 161 may function to correct the position of the EIC 124 so that the bottom surfaces of the EIC 124, the first semiconductor chip 121, and the second semiconductor chip 122 may be positioned at the same height in the third direction D3.

The sum of the length of the PIC 123 and the length of the EIC 124 in the third direction D3 may be less than the length of the first semiconductor chip 121 or the second semiconductor chip 122 in the third direction D3. The dummy insulating layer 161 may allow the bottom surfaces of the EIC 124, the first semiconductor chip 121, and the second semiconductor chip 122 to be positioned at the same height in the third direction D3. For example, the sum of the length of the dummy insulating layer 161, the length of the PIC 123, and the length of the EIC 124 in the third direction D3 may be equal to the length of the first semiconductor chip 121 or the second semiconductor chip 122. However, embodiments are not necessarily limited thereto.

In this case, the optical element 14 may extend through the dummy insulating layer 161 and connect the optical transport layer 132′ and the PIC 123.

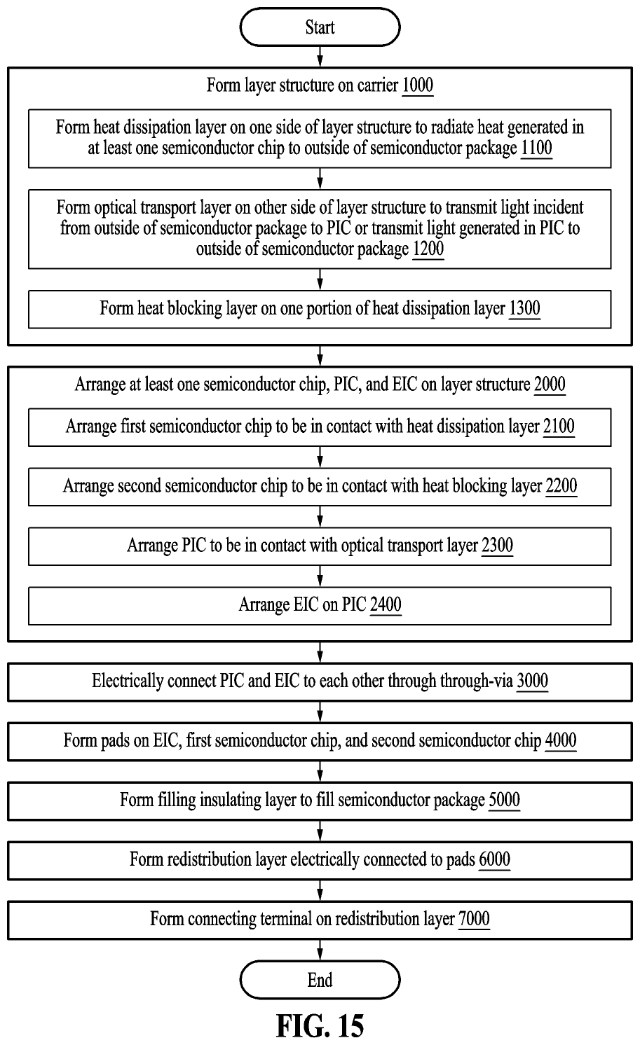

FIG. 15 is a flowchart illustrating a method of manufacturing a semiconductor package according to an embodiment of the present disclosure.

Referring to FIG. 15, a method of manufacturing a semiconductor package according to an embodiment of the present disclosure may include operation 1000 of forming a layer structure on a carrier, and operation 2000 of arranging at least one semiconductor chip, a PIC, and an EIC on the layer structure.

Operation 1000 of forming a layer structure on a carrier may include operation 1100 of forming a heat dissipation layer on one side of the layer structure to radiate heat generated in the at least one semiconductor chip to the outside of the semiconductor package, operation 1200 of forming an optical transport layer on the other side of the layer structure to transmit light incident from the outside of the semiconductor package to the PIC or transmit light generated in the PIC to the outside of the semiconductor package, and operation 1300 of forming a heat blocking layer on one portion of the heat dissipation layer. Operation 1000 of forming a layer structure on a carrier may be performed by a mechanism similar to the mechanism for operation 6000 of forming a redistribution layer.

In operation 1000 of forming a layer structure on a carrier, one portion of the optical transport layer and one portion of the heat dissipation layer may overlap each other. One portion of the optical transport layer may be arranged adjacent to the PIC, and one portion of the heat dissipation layer may be arranged spaced apart from the PIC. A surface where the optical transport layer and the heat dissipation layer face each other may be inclined in a direction toward the PIC to be arranged later. For example, the surface may be inclined with respect to the upper surface of the PIC 123. A mirror may be arranged on the surface where the optical transport layer and the heat dissipation layer face each other.

Operation 2000 of arranging at least one semiconductor chip, a PIC, and an EIC on the layer structure may include operation 2100 of arranging the first semiconductor chip to be in contact with the heat dissipation layer, operation 2200 of arranging the second semiconductor chip to be in contact with the heat blocking layer, operation 2300 of arranging the PIC to be in contact with the optical transport layer, and operation 2400 of arranging the EIC on the PIC.

In operation 2000 of arranging at least one semiconductor chip, a PIC, and an EIC, one surfaces, opposite to the carrier, of the EIC, the first semiconductor chip, and the second semiconductor chip may be positioned at the same height.

If the sum of the length of the PIC and the length of the EIC for a direction perpendicular to the carrier is less than the length of the first semiconductor chip or the second semiconductor chip for the direction perpendicular to the carrier, an operation of arranging a dummy insulating layer between the layer structure and the PIC may be further included. The dummy insulating layer may allow the one surfaces, opposite to the carrier, of the EIC, the first semiconductor chip, and the second semiconductor chip to be positioned at the same height.

The method of manufacturing a semiconductor package may further include operation 3000 of electrically connecting the PIC and the EIC to each other through a through-via, operation 4000 of forming pads on the EIC, the first semiconductor chip, and the second semiconductor chip, operation 5000 of forming a filling insulating layer to fill the semiconductor package, operation 6000 of forming a redistribution layer electrically connected to the pads, and operation 7000 of forming a connecting terminal on the redistribution layer. An operation of forming an optical element connecting the PIC and the EIC may be further included before or after operation 3000 of electrically connecting the PIC and the EIC to each other through a through-via.

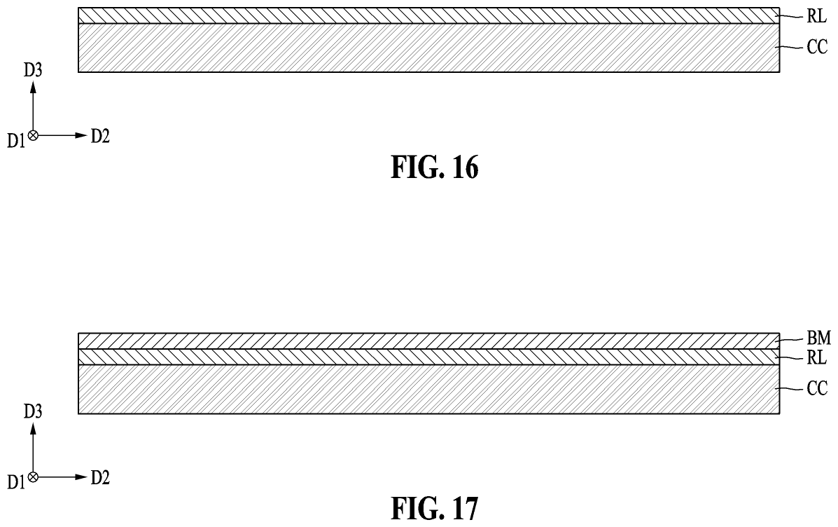

FIGS. 16 to 26 illustrate a process of manufacturing a semiconductor package according to an embodiment of the present disclosure.

Referring to FIG. 16, a release layer RL may be arranged on a carrier CC. The carrier CC may be, for example, a glass carrier. A laser debonding method may allow the reuse of the glass carrier after the process of manufacturing a semiconductor package is completed. During the process of detaching the carrier CC from the semiconductor package described below, the release layer RL may be detached from the semiconductor package together with the carrier CC.

Referring to FIG. 17, a barrier metal BM may be arranged on the release layer RL. During the process of detaching the carrier CC from the semiconductor package described below, the barrier metal BM may also be detached from the semiconductor package together with the carrier CC.

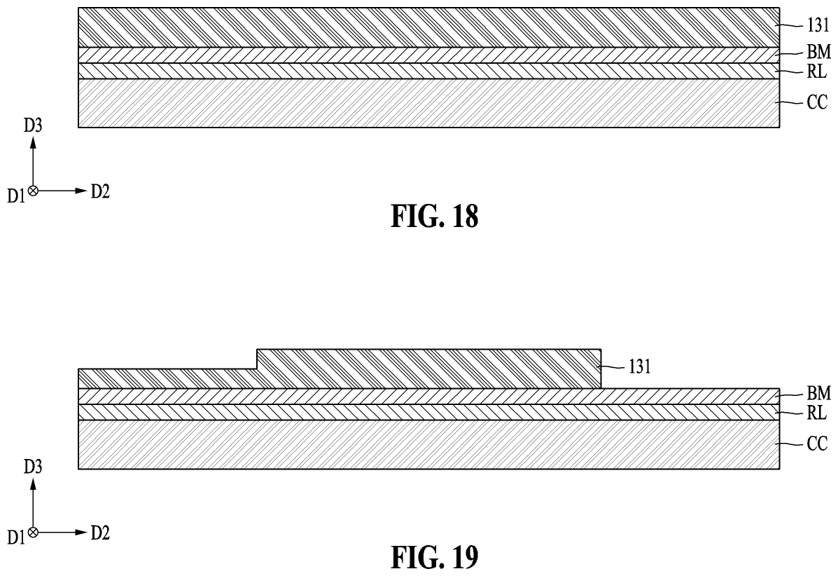

Referring to FIG. 18, a heat dissipation layer 131 may be deposited on the barrier metal BM. The heat dissipation layer 131 may be formed in a preset thickness.

Referring to FIG. 19, one side of the heat dissipation layer 131 may be completely removed. A portion of the other side of the heat dissipation layer 131 may be removed.

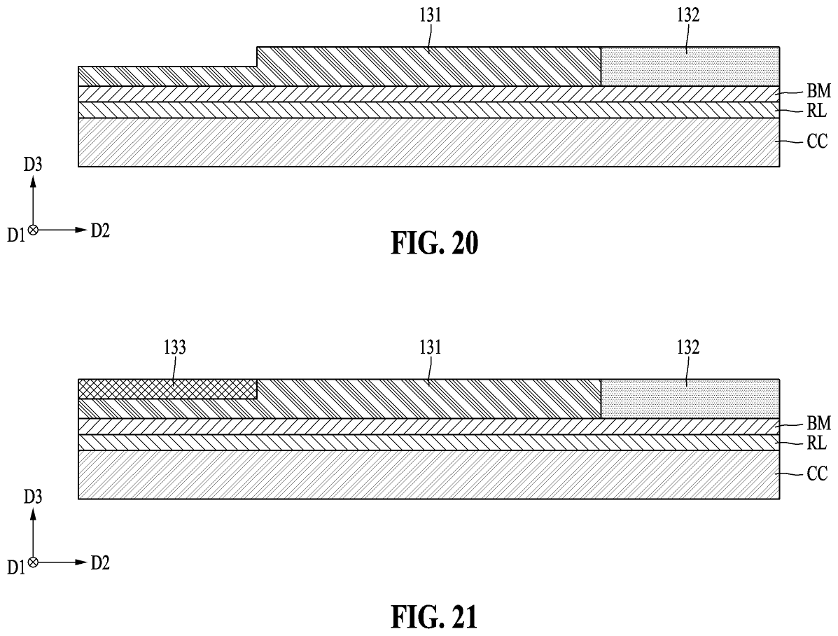

Referring to FIG. 20, an optical transport layer 132 may be deposited in the area where one side of the heat dissipation layer 131 is completely removed.

Referring to FIG. 21, a heat blocking layer 133 may be deposited in the area where a portion of the other side of the heat dissipation layer 131 is removed. One surfaces, opposite to the carrier CC, of the heat dissipation layer 131, the optical transport layer 132, and the heat blocking layer 133 may be formed at the same height. The one surfaces, opposite to the carrier CC, of the heat dissipation layer 131, the optical transport layer 132, and the heat blocking layer 133 may be arranged on the same plane.

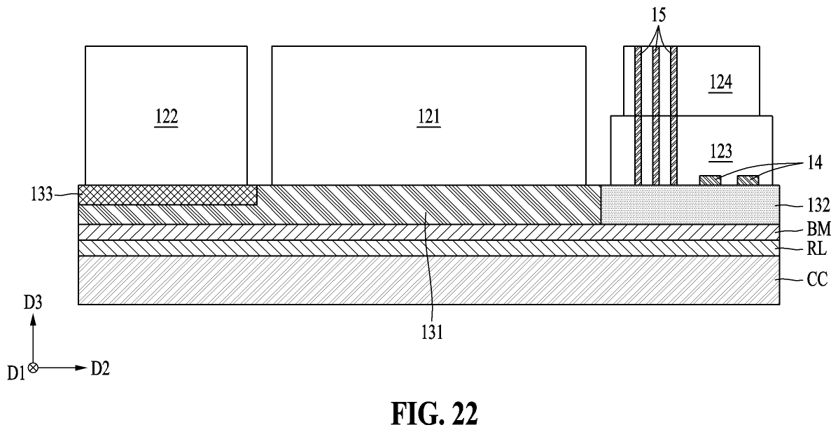

Referring to FIG. 22, a first semiconductor chip 121 may be arranged in contact with the heat dissipation layer 131. A second semiconductor chip 122 may be arranged in contact with the heat blocking layer 133. A PIC 123 may be arranged in contact with the optical transport layer 132. An EIC 124 may be stacked on the PIC 123 and arranged in contact with the PIC 123. The first semiconductor chip 121, the second semiconductor chip 122, the PIC 123, and the EIC 124 may be arranged in that order, but embodiments are not necessarily limited thereto. The arrangement order of the first semiconductor chip 121, the second semiconductor chip 122, the PIC 123, and the EIC 124 may be arbitrarily changed.

One surfaces, opposite to the carrier CC, of the first semiconductor chip 121, the second semiconductor chip 122, and the EIC 124 may be formed at the same height. Although not explicitly shown in FIG. 22, a dummy insulating layer may be arranged in a space between the optical transport layer 132 and the PIC 123, as needed. The sum of the length of the PIC 123 and the length of the EIC 124 in the third direction D3 may be less than the length of the first semiconductor chip 121 or the second semiconductor chip 122 in the third direction D3. The dummy insulating layer may allow the one surfaces, opposite to the carrier CC, of the first semiconductor chip 121, the second semiconductor chip 122, and the EIC 124 to be positioned at the same height.

An optical element 14 may be arranged between the optical transport layer 132 and the PIC 123. Through-vias 15 may be formed to electrically connect the PIC 123 and the EIC 124.

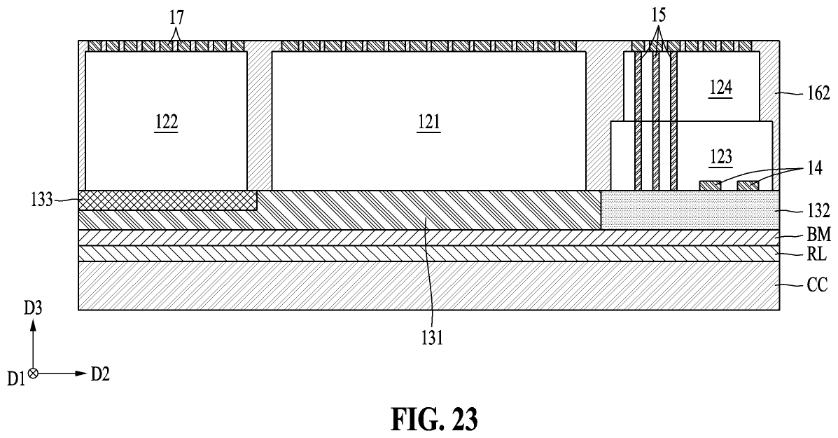

Referring to FIG. 23, pads 17 may be formed on the one surfaces, opposite to the carrier CC, of the first semiconductor chip 121, the second semiconductor chip 122, and the EIC 124. A filling insulating layer 162 may be formed to surround the first semiconductor chip 121, the second semiconductor chip 122, the PIC 123, and the EIC 124.

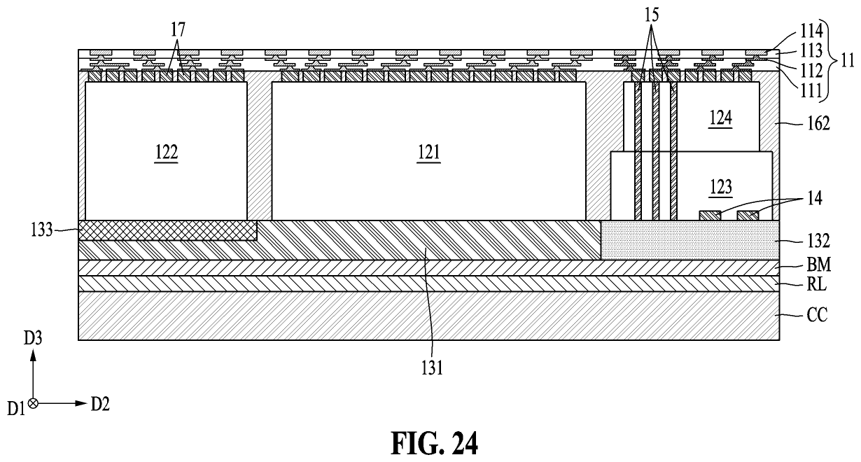

Referring to FIG. 24, a redistribution layer 11 may be formed to be electrically connected to the pads 17. The redistribution layer 11 may include a first redistribution insulating layer 111, a second redistribution insulating layer 113, a plurality of redistribution patterns 112 arranged in the first redistribution insulating layer 111, and a bump pattern 114 arranged in the second redistribution insulating layer 113.

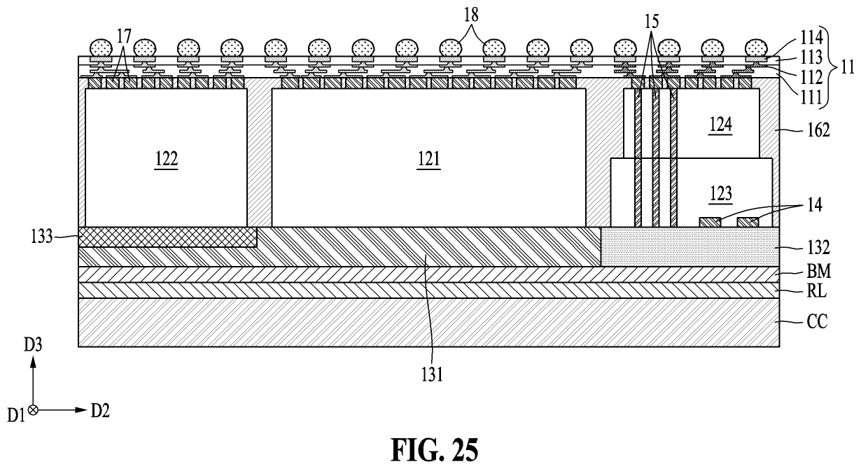

Referring to FIG. 25, a connecting terminal 18 may be formed to be electrically connected to the redistribution layer 11.

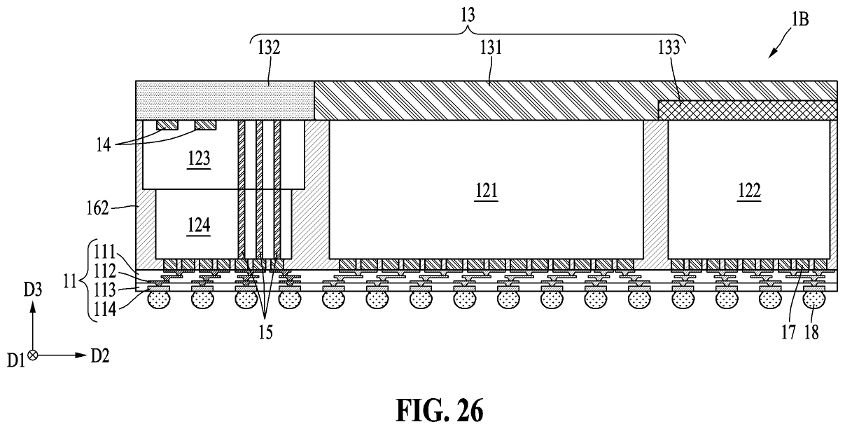

Referring to FIG. 26, a semiconductor package 1B may be turned over, and the carrier CC, the release layer RL, and the barrier metal BM may be detached and removed from the semiconductor package 1B.

Some of the processes described above may be replaced with processes according to modified embodiments described below.

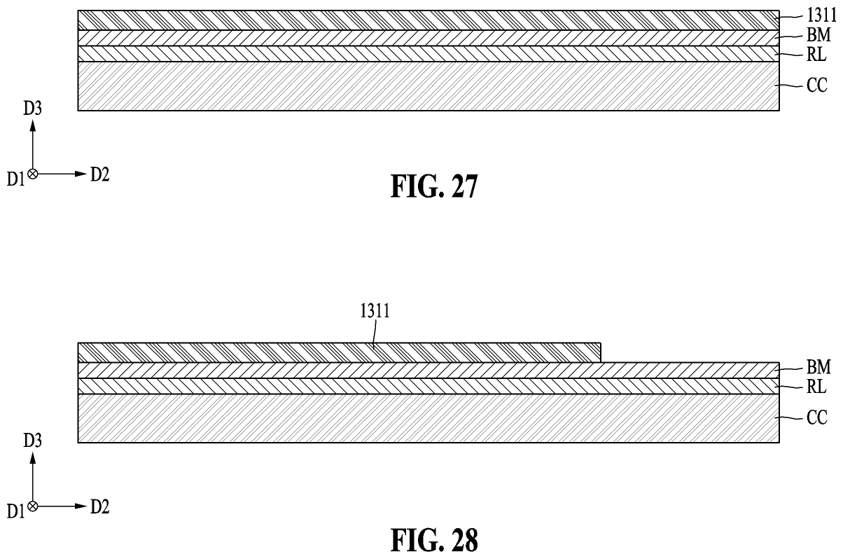

FIGS. 27 to 32 illustrate a portion of a process of manufacturing a semiconductor package according to another embodiment of the present disclosure. Among the processes of manufacturing a semiconductor package described above with reference to FIGS. 16 to 26, the processes shown in FIGS. 18 to 21 may be replaced with the processes shown in FIGS. 27 to 32.

Referring to FIG. 27, a first heat dissipation layer 1311 may be deposited on the barrier metal BM. The first heat dissipation layer 1311 may be formed in a preset thickness. The thickness of the first heat dissipation layer 1311 in the process shown in FIG. 27 may be less than the thickness of the heat dissipation layer in the process shown in FIG. 18. However, embodiments are not necessarily limited thereto.

Referring to FIG. 28, one side of the first heat dissipation layer 1311 may be completely removed.

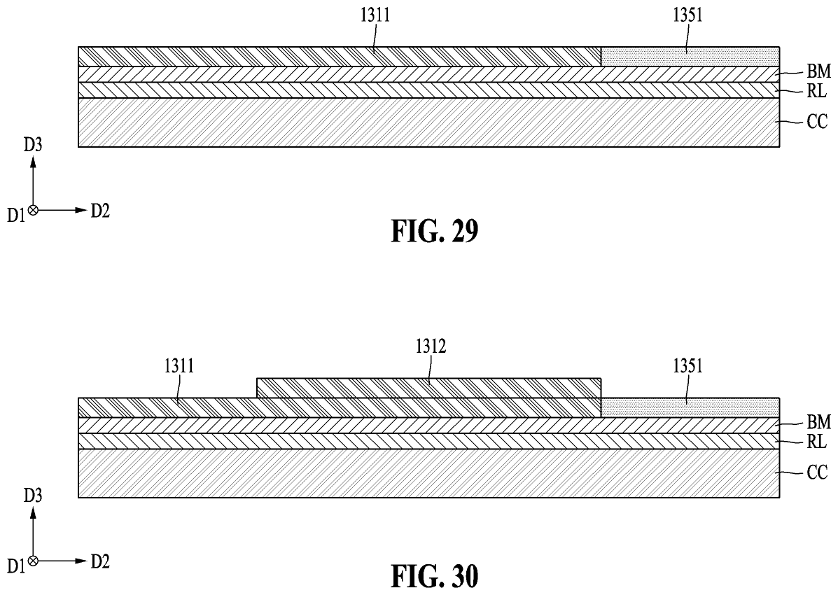

Referring to FIG. 29, a first optical transport layer 1351 may be deposited in the area where one side of the first heat dissipation layer 1311 is completely removed. One surfaces, opposite to the carrier CC, of the first heat dissipation layer 1311 and the first optical transport layer 1351 may be formed at the same height.

Referring to FIG. 30, a second heat dissipation layer 1312 may be deposited on one side of the first heat dissipation layer 1311. In this case, the second heat dissipation layer 1312 may not be formed on the other side of the first heat dissipation layer 1311.

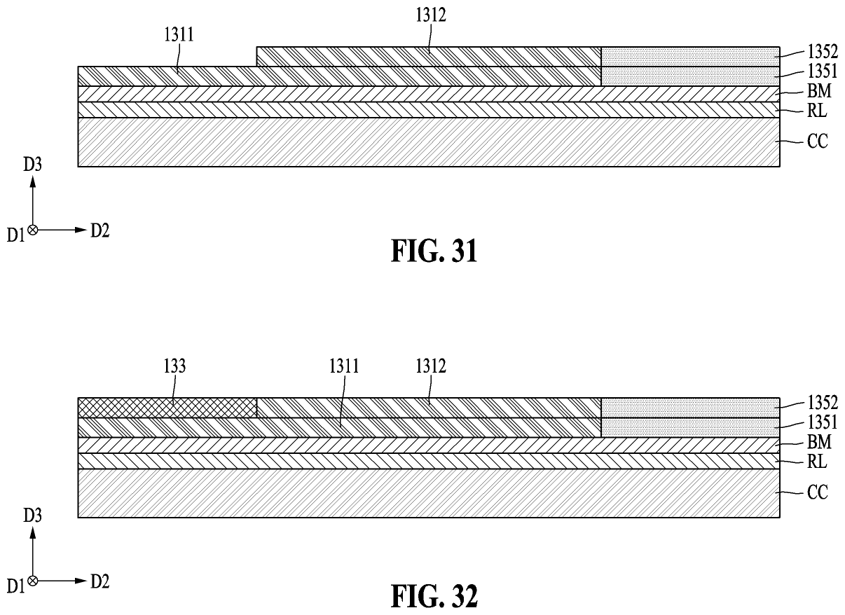

Referring to FIG. 31, a second optical transport layer 1352 may be deposited on the first optical transport layer 1351.

Referring to FIG. 32, a heat blocking layer 133 may be deposited on the other side of the first heat dissipation layer 1311. One surfaces, opposite to the carrier CC, of the second heat dissipation layer 1312, the second optical transport layer 1352, and the heat blocking layer 133 may be formed at the same height.

As described above, a semiconductor package according to the present disclosure may improve space efficiency by forming an optical transmission path through a layer structure. The semiconductor package may improve cooling efficiency and alleviate thermal coupling between semiconductor chips by forming a thermal dissipation path through a layer structure.

A method of manufacturing a semiconductor package according to the present disclosure may reduce manufacturing costs by using a glass carrier.

In conclusion, a semiconductor package and a method of manufacturing the semiconductor package according to the present disclosure may implement a semiconductor package that is more compact and improved in electrical and thermal characteristics.

A number of embodiments have been described above. Nevertheless, it should be understood that various modifications and variations may be made to these embodiments. For example, suitable results may be achieved if the described techniques are performed in a different order, and/or if components in a described system, architecture, device, or circuit are combined in a different manner, and/or replaced or supplemented by other components or their equivalents.

What is claimed is:

1. A semiconductor package comprising:
a redistribution layer;
a first semiconductor chip arranged on a first surface of the redistribution layer;
a photonic integrated circuit (PIC) arranged on the first surface and adjacent to a first side surface of the first semiconductor chip; and
a layer structure arranged on the first semiconductor chip and the PIC,
wherein the layer structure is configured to radiate heat generated from the first semiconductor chip to an outside, and transmit light incident from the outside to the PIC or transmit light generated from the PIC to the outside.

2. The semiconductor package of claim 1, further comprising:
a second semiconductor chip arranged on the first surface of the redistribution layer and adjacent to a second side surface, opposite to the first side surface, of the first semiconductor chip,
wherein the layer structure comprises:
a heat dissipation layer arranged on the first semiconductor chip or the second semiconductor chip; and
an optical transport layer arranged on the PIC.

3. The semiconductor package of claim 2,
wherein the layer structure further comprises:
a heat blocking layer arranged between the heat dissipation layer and the second semiconductor chip.

4. The semiconductor package of claim 2, further comprising:
an optical element arranged between the optical transport layer of the layer structure and the PIC.

5. The semiconductor package of claim 2,
wherein the optical transport layer is formed of a plurality of layers extending in a direction perpendicular to the first surface of the redistribution layer, and
wherein a waveguide pattern is formed in each layer of the plurality of layers.

6. The semiconductor package of claim 2,
wherein the optical transport layer is formed of a plurality of layers extending in a direction parallel to the redistribution layer, and
wherein a waveguide pattern is formed in each layer of the plurality of layers.

7. The semiconductor package of claim 6,
wherein a surface where the optical transport layer and the heat dissipation layer contact each other is inclined with reference to an upper surface of the PIC.

8. The semiconductor package of claim 6, further comprising:
a mirror arranged on a surface where the optical transport layer and the heat dissipation layer face each other,
wherein the mirror is inclined with respect to an upper surface of the PIC.

9. The semiconductor package of claim 2,
wherein one portion of the optical transport layer and one portion of the heat dissipation layer overlap each other in a vertical direction perpendicular to the first surface of the redistribution layer,
wherein the one portion of the optical transport layer contacts the PIC, and
wherein the one portion of the heat dissipation layer is spaced apart from the PIC.

10. The semiconductor package of claim 2, further comprising:
an electronic integrated circuit (EIC) arranged beneath the PIC.

11. The semiconductor package of claim 10,
wherein the PIC and the EIC are electrically connected to each other by a through-via.

12. The semiconductor package of claim 11,
wherein a bottom surface of the EIC, a bottom surface of the first semiconductor chip, and a bottom surface of the second semiconductor chip are positioned at a same height.

13. The semiconductor package of claim 12, further comprising:
a dummy insulating layer arranged between the layer structure and the PIC.

14. The semiconductor package of claim 10, further comprising:
a plurality of pads arranged between the first surface of the redistribution layer and each of the EIC, the first semiconductor chip, and the second semiconductor chip.

15. The semiconductor package of claim 1, further comprising:
a connecting terminal arranged on a second surface, opposite to the first surface, of the redistribution layer.

16. A method of manufacturing a semiconductor package, the method comprising:
forming a layer structure on a carrier; and
arranging at least one semiconductor chip, a photonic integrated circuit (PIC), and an electronic integrated circuit (EIC) on the layer structure,
wherein the forming of the layer structure comprises:
forming a heat dissipation layer on one side of the layer structure to radiate heat generated from the at least one semiconductor chip to an outside of the semiconductor package; and
forming an optical transport layer on the other side of the layer structure to transmit light incident from the outside of the semiconductor package to the PIC or transmit light generated from the PIC to the outside of the semiconductor package.

17. The method of claim 16,
wherein the forming of the layer structure further comprises forming a heat blocking layer on one portion of the heat dissipation layer.

18. The method of claim 17,
wherein the arranging of the at least one semiconductor chip including a first semiconductor chip and a second semiconductor chip, the PIC, and the EIC comprises:
arranging the first semiconductor chip on the layer structure and contacting the heat dissipation layer;
arranging the second semiconductor chip on the layer structure and contacting the heat blocking layer;
arranging the PIC on the layer structure and contacting the optical transport layer; and
arranging the EIC on the PIC.

19. The method of claim 18, further comprising:
electrically connecting the PIC and the EIC with each other through a through-via;
forming a plurality of pads on the EIC, the first semiconductor chip, and the second semiconductor chip; and
forming a filling insulating layer to fill the semiconductor package.

20. The method of claim 19, further comprising:
forming a redistribution layer electrically connected to the plurality of pads; and
forming a connecting terminal on the redistribution layer.
